(19) United States
(12) Patent Application Publication
(10) Pub. No.: US 2016/0297376 A1
(43) Pub. Date: Oct. 13, 2016

(54) VIBRATION DAMPENING ASSEMBLY FOR FIXING A DISPLAY DEVICE AND DISPLAY APPARATUS

(71) Applicants: BOE TECHOLOGY GROUP CO., LTD., Beijing (CN); BEIJING BOE SPECIAL DISPLAY TECHNOLOGY CO., LTD., Beijing (CN)

(72) Inventors: Zhiguo CHEN, Beijing (CN); Guogang GUO, Beijing (CN)

(73) Assignee: BOE TECHNOLOGY GROUP CO., LTD., Beijing (CN)

(21) Appl. No.: 14/437,145

(22) PCT Filed: Oct. 10, 2014
(86) PCT No.: PCT/CN2014/088365

§ 371 Date: Apr. 20, 2015

(30) Foreign Application Priority Data
May 28, 2014 (CN) 201420280364.5

(51) Int. Cl. B60R 11/02; F16M 13/02; F16F 15/08

(52) U.S. Cl. CPC B60R 11/0235; F16F 15/08; F16M 13/02; B60R 2011/0066

(57) ABSTRACT

A vibration dampening assembly for fixing a display device (15), comprising a bracket (14), a screw (11), a screw sleeve (12), and an I-shaped rubber ring (13), wherein the I-shaped rubber ring (13) has a shape of post and is provided with an axial through hole (131) therein, the bracket (14) or the display device (15) is bored to mount the I-shaped rubber ring (13), the screw sleeve (12) is provided in the axial through hole (131) of the I-shaped rubber ring (13), and the screw (11) passes through the screw sleeve (12) to fix the display device (15) on the bracket (14).

### TECHNICAL FIELD

Embodiments of the present invention relates to a vibration damping assembly for fixing a display device and a display apparatus.

### BACKGROUND

Currently, defect rate of on-vehicle televisions/displays (collectively referred to as on-vehicle display terminals) generally is twice more than that of domestic display, this is mainly because that the on-vehicle display terminals will be subject to vibration for a long time, and the vibration is likely to cause the capacitors, resistances, coils, chips in the terminal to be released, to cause wires to come off, to cause glass of a liquid crystal module to be broken, to cause film materials to be scraped, to cause the internal circuits to be poor connected, or the like. Therefore, it is necessary to provide a vibration damping means for the on-vehicle display terminals, esp. an internal liquid crystal module costs highly, and thus needs excellent vibration dampening means.

Currently, vibration dampening means used for the on-vehicle display terminal is to provide buffer materials such as buffer sponge, silicon rubber stripes, or the like at peripheries of the display screen so as to damp the peripheries of the screen. Such means is just suitable for dampening small size screens, however, for a large size display screen, it will take a large quantity of buffer materials. Furthermore, a preset clearance between the buffer material and the display screen is difficult to run, if the buffer material is pressed hard on the display screen, the buffer material will lose its vibration dampening function. If too loose, the display screen as a whole can not be positioned or positioned accurately, which will cause the display screen to be inclined or displaced in vibration.

In addition, there is another vibration dampening means in conventional arts, in this means, post-shaped rubber dampers with female threads at both ends are provided between a supporting structure and the display terminal to dampen the vibration. As shown in FIG. 1, a cylindrical support post 2 is welded to a lower mounting plate 4 at the lower end thereof, and the cylindrical support post 2 is fixed by screws fitted in round holes in the lower mounting plate 4. Then, by means of the post-shaped rubber damper 5 and an upper mounting plate 3, a mounting plate 1 for mounting the display terminal is mounted to the cylindrical support post 2. Finally, the display terminal is fixed on the mounting plate 1 by screws fitted in round holes in the mounting plate 1. Wherein, one end of the post-shaped rubber damper 5 is aligned with the through hole in the upper mounting plate 3 and fixed thereto by a screw 9, and the other end of the post-shaped rubber damper 5 is aligned with a corresponding counter bore in the mounting plate 1 and is fixed by a countersunk head screw. This vibration dampening structure will mainly dampening the vibration along the axial direction (in consistent with the lengthwise direction of the screw 9, perpendicular to the surface of the display terminal, usually the travelling direction of the vehicle), can not cope with the vibration in other directions at the same time, while in fact the vibration in the vertical direction is the largest one.

### SUMMARY

At least one embodiment of the present invention provides a vibration dampening assembly for fixing a display device, the vibration dampening assembly comprising a bracket, a screw, a screw sleeve and a I-shaped rubber ring. The I-shaped rubber ring renders a cylindrical shape and is provided with an axial through hole therein. The bracket or the display device is provided with a bore for mounting the I-shaped rubber ring, the screw sleeve is provided in the axial through hole of the I-shaped rubber ring, and the screw passes through the screw sleeve to fix the display device on the bracket.

In one embodiment according to the present disclosure, the bracket or the display device is provided with a bore to mount the I-shaped rubber ring, is that, the bracket is provided with a through hole with a slot, the slot has a narrow upper portion and a wide lower portion, is provided axially along the through hole, and the I-shaped rubber ring is engaged in the slot;

and the display device is provided with a threaded hole corresponding to the screw, the screw passes through the screw sleeve mounted in the I-shaped rubber ring to be screwed in the threaded hole in the display device.

In one embodiment according to the present disclosure, the bracket or the display device is provided with a bore to mount the I-shaped rubber ring, is that, the display device is provided with a through hole with a slot, the slot has a narrow upper portion and a wide lower portion and is axially provided along the through hole, the I-shaped rubber ring is engaged in the slot;

and the bracket is provided with a threaded hole corresponding to the screw, the screw passes through the screw sleeve mounted in the I-shaped rubber ring to be screwed in the threaded hole in the bracket.

In one embodiment according to the present disclosure, in the same vibration direction, where there are a plurality of through holes with slots in the bracket or the display device, at least two of these through holes have slots with different depth.

In one embodiment according to the present disclosure, the vibration dampening assembly further comprises an auxiliary damper, and the bracket is further provided with a second through hole for mounting the auxiliary damper;

one end of the auxiliary damper is formed into a shape of easily inserting and hardly removing, to engage in the second through hole of the bracket. The other end of the auxiliary damper is provided with an elastic platform against the edge of the display device.

In one embodiment according to the present disclosure, the end of the auxiliary damper having a shape of easily inserting and hardily removing is constructed by connecting a convex thick portion and a cylindrical thin portion, the convex thick portion has a maximum diameter as large as 115% to 135% of the diameter of the second through hole, and the cylindrical thin portion has a diameter as large as 80% to 99% of the diameter of the second through hole.

In one embodiment according to the present disclosure, the I-shaped rubber ring comprises circular rubber pads at both sides and a cylindrical rubber sleeve connecting the circular rubber pads. An outer diameter of the cylindrical rubber sleeve is as large as 90% to 99% of the width of the slot at its maximum width, a diameter of the circular rubber pad is as large as 90% to 99% of the diameter of the through hole, and the narrowest width of the slot is as large as 75% to 85% of the outer diameter of the cylindrical sleeve.

In one embodiment according to the present disclosure, the screw sleeve comprises a head pad corresponding to the head of the screw, and a sleeve corresponding to the stem of the screw, an outer diameter of the sleeve is as large as 90% to 99% of the diameter of the axial through hole of the I-shaped rubber ring.

In one embodiment according to the present disclosure, the screw sleeve is made of polymers composite material.

At least one embodiment of the present disclosure provides a display apparatus comprising any one of the above described vibration dampening assembly.

In the vibration dampening assembly for fixing a display device and the display apparatus according to embodiments of the present disclosure, the display device is mounted on the bracket by screws, and the screws serve to position the display device. And at the same time, a screw sleeve and an I-shaped rubber ring are provided between the screw and the bracket, when vibration occurs for example in the vertical (upward and downward) or the longitudinal (forward and rearward) directions, the bracket is vibrated following the vibration source (a vehicle, etc.), and transfers the vibration to the I-shaped rubber ring. The I-shaped rubber ring absorbs the vibration displacement of the bracket by being pressed and deformed in rightward and leftward or forward and rearward directions, as a result, only a few vibration displacement is transferred to the display device. Thus, the problem of inaccurately positioning and dampening less effective in main vibration direction in conventional vibration dampening assembly is resolved. The vibration dampening assembly according to the present disclosure can be easily assembled and is capable of dampening vibrations in multi-directions.

### BRIEF DESCRIPTION OF THE DRAWINGS

In order to clearly illustrate the technical solution of the embodiments of the disclosure, the drawings of the embodiments will be briefly described in the following; it is obvious that the described drawings are only related to some embodiments of the disclosure and thus are not limitative of the disclosure.

FIG. 1 is a schematic view illustrating the structure of the on-vehicle vibration dampening and fixing device for a liquid crystal display as known by the present inventor;

FIG. 2 is a schematic view for illustrating the installation of the vibration dampening assembly according to an embodiments of the present disclosure;

FIG. 3 is a partly enlarged schematic view for illustrating the vibration dampening assembly in FIG. 2;

FIG. 4 is an exploded diagram for illustrating the connection relationship among components of the vibration dampening assembly according an the embodiment of the present disclosure;

FIG. 5 is a view illustrating vibration dampening effect of the vibration dampening assembly according to an embodiment of the present disclosure when the vibration occurs in vertical or longitudinal directions;

FIG. 6 is a view illustrating vibration dampening effect of the vibration dampening assembly according to an embodiment of the present disclosure when irregular vibration occurs;

FIG. 7 is a view illustrating vibration dampening effect of the vibration dampening assembly according to an embodiment of the present disclosure when the vibration occurs in lateral direction;

FIG. 8 is a view illustrating vibration dampening effect of an auxiliary damper according to an embodiment of the present disclosure;

FIG. 9 is a schematic view illustrating the structure and the size of the screw sleeve according to an embodiment of the present disclosure;

FIG. 10 is a schematic view illustrating the structure and the size of the I-shaped rubber ring according an embodiment of the present disclosure;

FIG. 11 is a schematic view illustrating the structure and the size of the through hole with a slot in the bracket according to an embodiment of the present disclosure;

FIG. 12 is a schematic view illustrating the structure and the size of an auxiliary damper according to an embodiment of the present disclosure; and

FIG. 13 is a schematic view illustrating the structure and the size of a second through hole in the bracket according to an embodiment of the present disclosure.

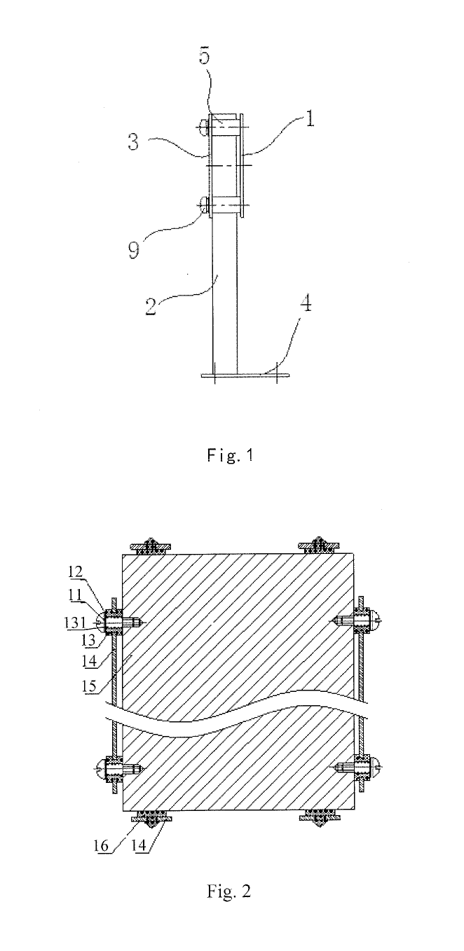

### DETAILED DESCRIPTION

In order to make objects, technical details and advantages of the embodiments of the invention apparent, the technical solutions of the embodiments will be described in a clearly and fully understandable way in connection with the drawings related to the embodiments of the invention. Apparently, the described embodiments are just a part but not all of the embodiments of the invention. Based on the described embodiments herein, those skilled in the art can obtain other embodiment(s), without any inventive work, which should be within the scope of the invention.

Embodiments of the present disclosure provide a vibration dampening assembly for fixing a display device and a display apparatus, by which the problem of inaccurately positioning, dampening less effective in main vibration direction as occurred in conventional vibration dampening assemblies can be resolved. And furthermore, the vibration dampening assembly can be easily mounted and is capable of dampening vibrations in multi-directions.

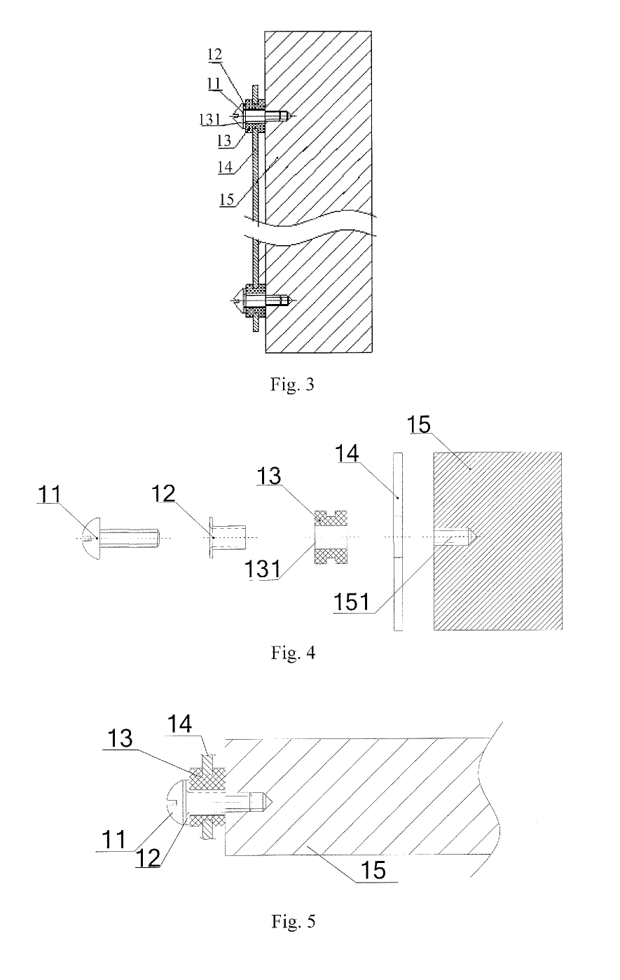

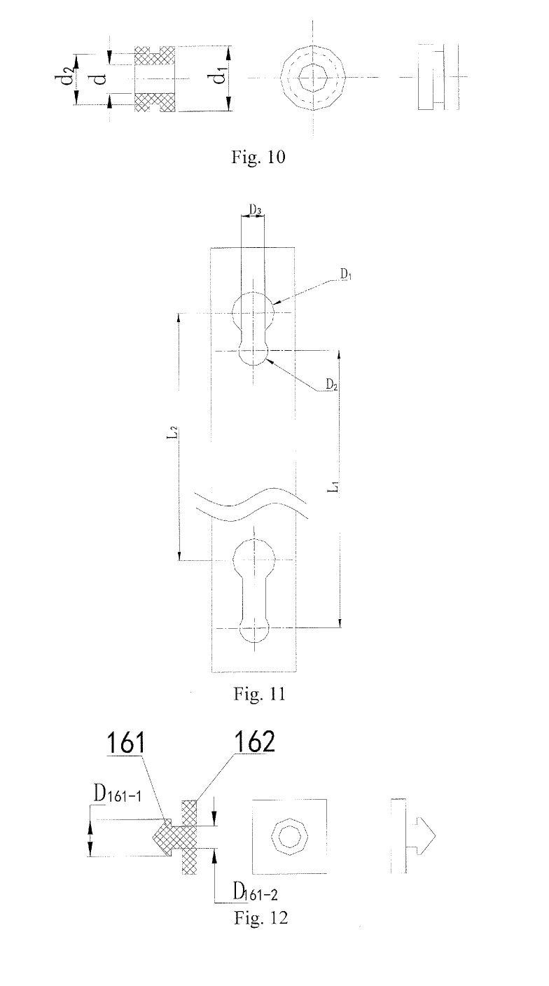

Embodiments of the present disclosure provide a vibration dampening assembly for fixing a display device, as illustrated in FIG. 2, FIG. 3 and FIG. 4, the vibration dampening assembly comprises a bracket 14, a screw 11, a screw sleeve 12 and an I-shaped rubber ring 13. As illustrated in FIG. 10, the I-shaped rubber ring 13 has a cylindrical shape, and is provided with an axial through hole 131 therein. The bracket 14 or the display device 15 is bored to mount the I-shaped rubber ring 13, the screw sleeve 14 is provided in the axial through hole 131 of the I-shaped rubber ring 13, and the screw 11 passes through the screw sleeve 13 to fix the display device to the bracket 14.

The vibration dampening assembly according to the present embodiment is used to fix the display device 15, and comprises a bracket 14, a screw 11, a screw sleeve 12 and an I-shaped rubber ring 13. The display device 15 is a general designation for all the display apparatus used in vibration environment, and can be a liquid crystal display panel, a liquid crystal module, a liquid crystal terminal or other display terminal or device. The screw 11 provides position and fixing function for the display device 15, such as a liquid module. The screw sleeve 12 is provided between the screw 11 and the I-shaped rubber ring 13, and mainly functions to increase buffering area and prevent the I-shaped rubber ring 13 from being damaged by the screw. Material for the screw sleeve 12 can employ metal material, or polymers composite material, when employing the polymers composite material (that is, the screw sleeve 12 is made from polymers composite material), ground connection between the display device 15 and the bracket 14 (or outer case) is isolated, clutter signal is prevented from cross-talking with the display device 15 through the outer case and influencing on display quality. The I-shaped rubber ring 13 is made of rubber with high dampening coefficient, and is the main damping component. The bracket 14 is used to mount and fix the display device such as a liquid crystal module, a liquid crystal terminal, or the like, and is generally bored to fit the I-shaped rubber ring 13 in place.

As illustrated in FIG. 4, which is an explored perspective view of the above vibration dampening assembly, the bracket 14 is provided with a through hole or a slot for mounting the I-shaped rubber ring 13, the display device 15 is provided with a threaded hole 151. When assembling, the I-shaped rubber ring 13 is fitted into the through hole of the bracket 14, the screw sleeve 12 is fitted in the axial through hole 131 of the I-shaped rubber ring 13, and the screw 11 passes through the screw sleeve 12 to be screwed into the threaded hole 151 on the display device 15, thus the display device 15 is fixed on the bracket 14. When vibration occurs, the I-shaped rubber ring 13 is pressed and deformed in the leftward and rightward direction or the forward and rearward direction to absorb the vibration displacement of the bracket, and thus effectively resolves the problems of inaccurate positioning and less effectively dampening in main direction, and so on in the conventional vibration dampening means, and can be easily mounted and is capable of dampening the vibrations in multi-directions.

In order to more clearly illustrate the structure of the vibration dampening assembly according to the embodiments of the present disclosure to the person skilled in the art, hereinafter, the vibration dampening assembly according to the embodiments of the present disclosure and its application will be described in detail.

As illustrated in FIG. 2 or FIG. 3, in the case that the vibration dampening assembly is used to fix an on-vehicle display device, the on-vehicle display device is generally provided vertically (perpendicular to the traveling direction of the vehicle, and referred to as the vertical direction, in short), at this time, the vibration in the vertical direction which is the main vibration direction, is the largest. Therefore, usually, thread holes are provided in vertical edges at both sides of the on-vehicle display device, and the mounting direction of the screws 11 is perpendicular to the main vibration direction. The bracket 14 is bored to fit the I-shaped rubber ring 13 in place. Upon mounting, firstly, the I-shaped rubber ring 13 is mounted to the bracket 14, then the screw sleeve 12 is mounted in the axial through hole of the I-shaped rubber ring 13, and then the screw 11 passes through the screw sleeve 12 to be screwed into the thread hole in the display device 15. Of course, the on-vehicle display device can also be bored to fit the I-shaped rubber ring 13 in place, while the bracket 14 is provided with threaded holes. Upon mounting, the I-shaped rubber ring 13 is mounted on the on-vehicle display device, the screw sleeve 12 is mounted in the axial through hole of the I-shaped rubber ring 13, and then the screw 11 passes through the screw sleeve 12 to be screwed into the threaded hole in the display device 15.

As illustrated in FIG. 11, for example, the brackets 14 is provided with a through hole 141 with a slot 142, the slot has a narrow upper portion and a wide lower portion, and is provided axially along the through hole 141. Upon mounting, the I-shaped rubber ring is passed through the through hole 141, and force is applied towards the slot 142, to engage the I-shaped rubber ring 13 in the slot 142. Then, the screw sleeve 12 is provided in the axial through hole 131 of the I-shaped rubber ring 13, the screw 11 passes through the screw sleeve 12 in the I-shaped rubber ring 13 (alternatively, the screw 11 is firstly inserted in the screw sleeve 12, and then passes through the axial through hole 131 of the I-shaped rubber ring 13 together with the screw sleeve 12) to be mounted into the threaded hole 151 on the display device. The display device 15 is provided with a threaded hole 152 corresponding to the screw 11. Similarly, the through hole 141 with the slot can also be provided in the display device 15, and the threaded hole 151 is provided on the bracket, the mounting method is substantively the same as above, and will not described any more.

The shape of the slot 142 is generally matched with the outer shape and the size of the I-shaped rubber ring. In the present embodiment, the I-shaped rubber ring 13 has a cylindrical shape, and the bottom of cross section of the above slot 142 renders an arc larger than a half circle. Upon implementation, the I-shaped rubber ring 13 can be enforced by enforcement ribs, or by changing the outer shape (but the main structure of the I-shaped rubber ring 13 does not change, as long as its outer shape is matched with the above slot 142.

What has been described above is only several application scenarios of the vibration dampening assembly according to the embodiments of the present disclosure, within the technical scope disclosed by the present disclosure, some variation or substitution can be easily made as necessary by the person skilled in the art without influencing its effect.

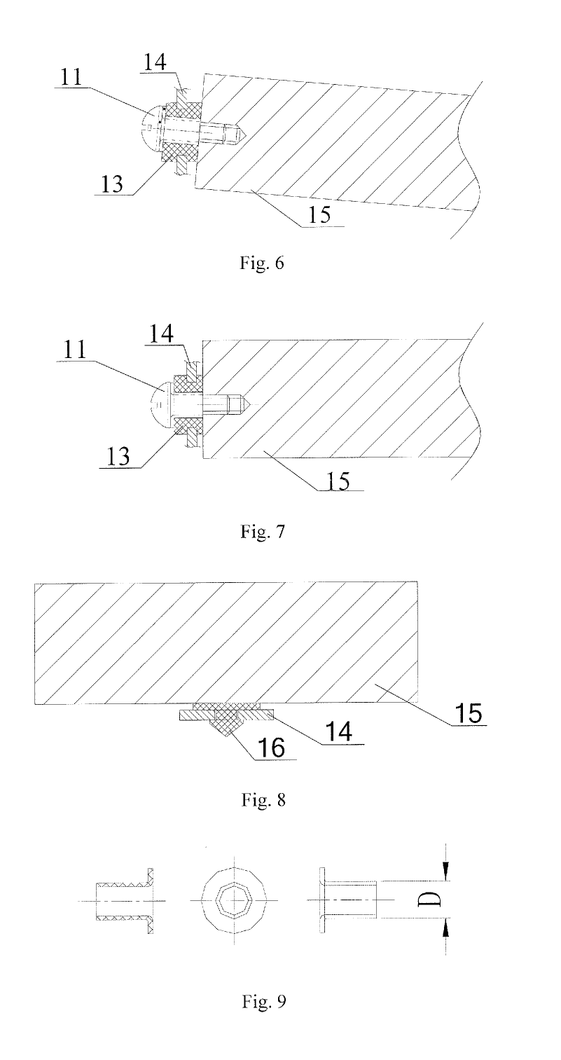

As illustrated in FIG. 5, when the vibration in the vertical direction (upward and downward) or in the longitudinal direction (forward and rearward) occurs, the bracket 14 is vibrated following the vibration source (vehicle, etc.), and transfers the vibration to the I-shaped rubber ring 13. Since the I-shaped rubber ring 13 is made of buffer material with high damping coefficient, it will be pressed and deformed in the vertical or the longitudinal direction so as to absorb the vibration displacement happening to the bracket 14, and less vibration displacement will be transferred to the screw 11 (together with the display device such as a liquid crystal module, a liquid crystal terminal, or the like). FIG. 6 illustrates a situation that the I-shaped rubber ring 13 is pressed and partially deformed to absorb the vibration when irregular vibration occurs. FIG. 7 illustrates a situation that the I-shaped rubber ring 13 is deformed due to being pressed laterally to absorb the vibration when lateral (rightward and leftward) vibration occurs. In suammary, it is clear that the vibration dampening assembly according to the present embodiment is capable of not only dampening the vibration in the main direction (vertical direction in the present embodiment), but also dampening the vibrations in other directions, and is capable of removing the defects of inaccurate positioning and less effective in dampening the vibration in main direction, and is easy to be mounted.

Each of the components of the vibration dampening assembly according to the present embodiment need to be used cooperatively, and the dimension fitting relationship therebetween are illustrated in FIG. 9, FIG. 10, FIG. 11 and FIG. 12. For example, the screw sleeve 12 as illustrated in FIG. 9 comprises a head pad corresponding to the head of the screw 11 and a sleeve corresponding to the stem of the screw 11. Since the sleeve is needed to be fitted in the axial through hole 131 of the I-shaped rubber ring 13 upon assembling, in order to guarantee the sleeve rendering good load bearing, generally, it is required that the outer diameter D of the sleeve is as large as 90% to 99% of the diameter d of the axial through hole 131 of the I-shaped rubber ring 13. In an embodiment of the present disclosure, the outer diameter D of the sleeve is 95% of the diameter d of the axial through hole 131.

In addition, upon mounting, the I-shaped rubber ring 13 goes through the through hole 141, and force is applied to the slot 142 to engage the I-shaped rubber ring 13 in the slot 142. In order to facilitate mounting the I-shaped rubber ring 13 and engaging the same in the slot 142, the outer surface of the I-shaped rubber ring 13 has a dimension fitted with the through hole 141 and the slot 142, and the dimension fitting relationship depends on elasticity of the material for the I-shaped rubber ring 13. The I-shaped rubber ring 13 comprises circular rubber pads at both sides thereof and a cylindrical rubber sleeve connecting the circular rubber pads. Generally, when designing, it is required that the outer diameter d1 of the cylindrical rubber sleeve is as large as 90% to 99% of the greatest width D2 of the slot 142, and the diameter d1 of the circular rubber pad is as large as 90% to 99% of the diameter D1 of the through hole, the opening width D3 of the slot 142 (at its narrowest position) is as large as 75% to 85% of the outer diameter d2 of the cylindrical rubber sleeve. In one embodiment, the outer diameter d2 of the cylindrical rubber sleeve is 95% of the greatest width D2 of the slot 142, the diameter d1 of the circular pad is 95% of the diameter D1 of the through hole, and the opening width D3 of the slot 142 is 80% of the outer diameter d2 of the cylindrical rubber sleeve.

In addition, upon implementation, usually, a plurality of through holes 141 with slot are provided on the same bracket (or the same display device), and at this time, in order to prevent the vibration dampening structure from entirely disengaging from the through hole 141 of the bracket upon drastic vibration, it is usually required that in the same vibration direction, at least two through holes 141 among these through holes 141 have the slots 142 with different depths, that is, the slots of the through holes have different depths, it is indicated in FIG. 11 as L1≠L2, wherein L1 is a distance between two through holes 141, and L2 is a distance between two corresponding slots 142.

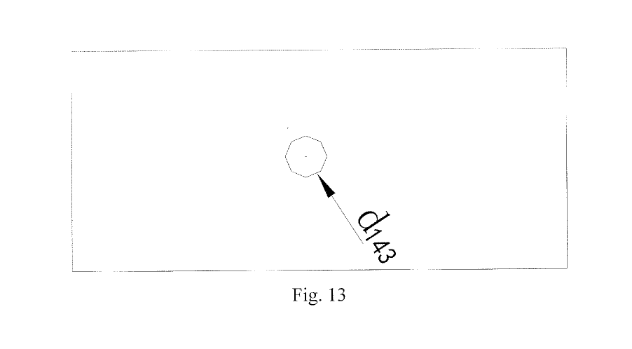

For example, as illustrated in FIG. 2, FIG. 12 and FIG. 13, the above vibration dampening assembly can further comprise an auxiliary damper 16, and the bracket 14 can further be provided with a second through hole 143 for mounting the auxiliary damper 16. One end of the auxiliary damper 16 is formed in a shape 161 of easily inserting but hardly removing, and is engaged in the second through hole 143 of the bracket 14. The other end of the auxiliary damper 16 is provided with an elastic platform 162 against an edge of the display device 15.

In practice, the bracket 14, the screw 11, the screw sleeve 12 and the I-shaped rubber ring 13 can be deemed as a main vibration dampening structure, and the auxiliary damper 16 is an auxiliary vibration dampening structure. The main vibration dampening structure is generally provided along the main vibration direction of the display device (e.g. the vertical direction of the on-vehicle display), but there is no requirement on the auxiliary vibration dampening structure. Usually, the auxiliary vibration dampening structure is used in cooperation with the main vibration dampening structure, and for example, is provided along a direction other than the main vibration direction, so that when the display assembly is subjected to strong impact or vibration, it will not be displaced so much to damage the main vibration dampening structure, and thus a good vibration dampening effect can be obtained.

It should be noted that, the main vibration dampening structure is a structure that is composed of four components including the screw 11, the screw sleeve 12, the I-shaped rubber ring 13 and the bracket 14 and is used to fix the liquid crystal module, so that the display device is flexibly connected to the vibration source (e.g. the bracket, the outer case, or the like), to improve resistance of the display device to the vibration. The main vibration dampening structure can be implemented solely, or can also be used in cooperation with the auxiliary damper 16. As illustrated in FIG. 2, the on-vehicle display is provided with threaded holes at two side edges in vertical direction, for mounting the main vibration dampening structure (vertical main vibration direction), and is also provided with the auxiliary dampers 16 at the upper and lower side (a lateral direction perpendicular to the vertical direction). The auxiliary vibration dampening structure restricts the vertical displacement of the on-vehicle display.

One end of the above auxiliary vibration damper 16 is formed into a shape 161 of easily inserting but hardly removing, and is mounted in the second through hole 143 of the bracket 14, the shape 161 is matched with the shape and size of the second through hole 143. As illustrated in FIG. 12, the shape 161 of easily inserting and hardly removing is formed by connecting a convex thick portion and a cylindrical thin portion, the convex thick portion has a maximum diameter D₁₆₋₁ as large as 115% to 135% of the diameter d₁₄₃ of the second through hole 143, and the cylindrical thin portion has a diameter D₁₆₋₂ as large as 80% to 99% of the diameter d₁₄₃ of the second through hole 143. In one embodiment, the maximum diameter D₁₆₋₁ of the convex thick portion is 120% of the diameter d of the second through hole 143, and the diameter D₁₆₋₂ of the cylindrical thin portion is 90% of the diameter d₁₄₃ of the second through hole 143, this configuration facilitates the convex thick portion to be inserted into the second through hole 143 to be mounted, and also facilitates the convex thick portion to be tightly engaged in the second through hole 143 after mounting and difficult to be removed.

It should be noted that the shape of the auxiliary damper 16 may be changed, and can be a square, a circle, a T shape, or the like, but the key point thereof lies in the shape of easily inserting but difficult removing formed at one end thereof, and the elastic platform at the other end thereof is not changed.

The present embodiment provides a vibration dampening structure composed of a main vibration dampening structure and an auxiliary vibration dampening structure, the main vibration dampening structure composed four components including the screw, the screw sleeve, the I-shaped rubber ring and the bracket to flexibly fix the display device to the outer case to improve resistance of the display device to vibration. The auxiliary structures are provided at the upper and lower sides of the display device, are composed of the auxiliary damper and the bracket, to withstand the strong impact or vibration applied to the display device, so that the display device will not be displaced so much which will damage the main vibration dampening structure, and thus the display device is protected.

At least one embodiment of the present disclosure further provides a display apparatus comprising any one of the above described vibration dampening assembly. Wherein the display apparatus can employ any one of the above vibration dampening assembly to fix a display device, the display device can be a liquid crystal panel or a liquid crystal screen, an OLED panel or screen, and so on. The display apparatus can by any product or component having display function, such as an electronic paper, a mobile phone, a tablet computer, a laptop computer, a digital photo frame, a navigator, and so on, and especially is suitable to the portable display apparatus used in vibration environment.

Each of the embodiments are described in a progressive manner in the present description, the same or similar part among the embodiments can be referred to each other, and the focus of each of the embodiments are different from each other.

The foregoing are merely exemplary embodiments of the disclosure, but are not used to limit the protection scope of the disclosure. The protection scope of the disclosure shall be defined by the attached claims.

The present disclosure claims priority of Chinese Patent Application No. 201420280364.5 filed on May 28, 2014, the disclosure of which is hereby entirely incorporated by reference.

1. A vibration dampening assembly for fixing a display device, comprising a bracket, a screw, a screw sleeve, and an I-shaped rubber ring;
wherein the I-shaped rubber ring is provided with an axial through hole therein, the bracket or the display device is bored to mount the I-shaped rubber ring, the screw sleeve is provided in the axial through hole of the I-shaped rubber ring, and the screw passes through the screw sleeve to fix the display device on the bracket.

2. The vibration dampening assembly according to claim 1, wherein the bracket is provided with a through hole with a slot, the slot has a narrow upper portion and a wide lower portion, and is provided axially along the through hole, the I-shaped rubber ring is engaged in the slot;
the display device is provided with a threaded hole corresponding to the screw, the screw passes through the screw sleeve in the I-shaped rubber ring to be screwed into the threaded hole in the display device.

3. The vibration dampening assembly according to claim 1, wherein the display device is provided with a through hole with a slot, the slot has a narrow upper portion and a wide lower portion, and is provided axially along the through hole, the I-shaped rubber ring is engaged in the slot;
the bracket is provided with a threaded hole corresponding to the screw, the screw passes through the screw sleeve in the I-shaped rubber ring to be screwed into the threaded hole in the bracket.

4. The vibration dampening assembly according to claim 2, wherein:
there are a plurality of the through holes with slots in the bracket or the display device along a same direction, and at least two through holes of these through holes have their slots different in depth.

5. The vibration dampening assembly according to claim 1, further comprising an auxiliary damper, the bracket is further provided with a second through hole for mounting the auxiliary damper,
one end of the auxiliary damper is formed into a shape of easily inserting and hardly removing, and engaged in the second through hole of the bracket, and the other end of the auxiliary damper is provided with an elastic platform to against an edge of the display device.

6. The vibration dampening assembly according to claim 5, wherein, the end of the auxiliary damper having a shape of easily inserting and hardly removing is constructed by connecting a convex thick portion and a cylindrical thin portion, the convex thick portion has a maximum diameter as large as 115% to 135% of the diameter of the second through hole, and the cylindrical thin portion has a diameter as large as 80% to 99% of the diameter of the second through hole.

7. The vibration dampening assembly according to claim 2, wherein, the I-shaped rubber ring comprises circular rubber pads at both sides and a cylindrical rubber sleeve connecting the circular rubber pads,
an outer diameter of the cylindrical rubber sleeve is as large as 90% to 99% of the greatest width of the slot, a diameter of the circular rubber pad is as large as 90 to 99% of an diameter of the through hole, and the width of the slot at its narrowest position is as large as 75% to 85% of the outer diameter of the cylindrical rubber sleeve.

8. The vibration dampening assembly according to claim 1, wherein the screw sleeve comprises a head pad corresponding to the head of the screw, and a sleeve corresponding to a stem of the screw,
an outer diameter of the sleeve is as large as 90% to 99% of a diameter of the axial through hole of the I-shaped rubber ring.

9. The vibration dampening assembly according to claim 1, wherein:
the screw sleeve is a screw sleeve made of polymers composite material.

10. A display apparatus comprising the vibration dampening assembly according to claim 1.

11. The vibration dampening assembly according to claim 3, wherein:
there are a plurality of the through holes with slots in the bracket or the display device along a same direction, and at least two through holes of these through holes have their slots different in depth.

12. The vibration dampening assembly according to claim 2, further comprising an auxiliary damper, the bracket is further provided with a second through hole for mounting the auxiliary damper,
one end of the auxiliary damper is formed into a shape of easily inserting and hardly removing, and engaged in the second through hole of the bracket, and the other end of the auxiliary damper is provided with an elastic platform to against an edge of the display device.

13. The vibration dampening assembly according to claim 3, further comprising an auxiliary damper, the bracket is further provided with a second through hole for mounting the auxiliary damper,
one end of the auxiliary damper is formed into a shape of easily inserting and hardly removing, and engaged in the second through hole of the bracket, and the other end of the auxiliary damper is provided with an elastic platform to against an edge of the display device.

14. The vibration dampening assembly according to claim 4, further comprising an auxiliary damper, the bracket is further provided with a second through hole for mounting the auxiliary damper,
one end of the auxiliary damper is formed into a shape of easily inserting and hardly removing, and engaged in the second through hole of the bracket, and the other end of the auxiliary damper is provided with an elastic platform to against an edge of the display device.

15. The vibration dampening assembly according to claim 3, wherein, the I-shaped rubber ring comprises circular rubber pads at both sides and a cylindrical rubber sleeve connecting the circular rubber pads,
an outer diameter of the cylindrical rubber sleeve is as large as 90% to 99% of the greatest width of the slot, a diameter of the circular rubber pad is as large as 90 to 99% of an diameter of the through hole, and the width of the slot at its narrowest position is as large as 75% to 85% of the outer diameter of the cylindrical rubber sleeve.

16. The vibration dampening assembly according to claim 4, wherein, the I-shaped rubber ring comprises circular rubber pads at both sides and a cylindrical rubber sleeve connecting the circular rubber pads,
an outer diameter of the cylindrical rubber sleeve is as large as 90% to 99% of the greatest width of the slot, a diameter of the circular rubber pad is as large as 90 to 99% of an diameter of the through hole, and the width of the slot at its narrowest position is as large as 75% to 85% of the outer diameter of the cylindrical rubber sleeve.

17. The vibration dampening assembly according to claim 2, wherein the screw sleeve comprises a head pad corresponding to the head of the screw, and a sleeve corresponding to a stem of the screw,
an outer diameter of the sleeve is as large as 90% to 99% of a diameter of the axial through hole of the I-shaped rubber ring.

18. The vibration dampening assembly according to claim 3, wherein the screw sleeve comprises a head pad corresponding to the head of the screw, and a sleeve corresponding to a stem of the screw,
an outer diameter of the sleeve is as large as 90% to 99% of a diameter of the axial through hole of the I-shaped rubber ring.

19. The vibration dampening assembly according to claim 4, wherein the screw sleeve comprises a head pad corresponding to the head of the screw, and a sleeve corresponding to a stem of the screw,
an outer diameter of the sleeve is as large as 90% to 99% of a diameter of the axial through hole of the I-shaped rubber ring.

20. The vibration dampening assembly according to claim 5, wherein the screw sleeve comprises a head pad corresponding to the head of the screw, and a sleeve corresponding to a stem of the screw,
an outer diameter of the sleeve is as large as 90% to 99% of a diameter of the axial through hole of the I-shaped rubber ring.
